(19) United States
(12) Patent Application Publication
(10) Pub. No.: US 2004/0149647 A1
(43) Pub. Date: Aug. 5, 2004

(54) Filter element flow diverter barrier and method

(75) Inventors: John R. Hampton, Houston, TX (US); Greg P. Wallace, Houston, TX (US)

Correspondence Address: JENKENS & GILCHRIST, 1401 MCKINNEY, SUITE 2700, HOUSTON, TX, 77010, US

(73) Assignee: Filtration Technology Corporation, Houston, TX

(21) Appl. No.: 10/754,202

(22) Filed: Jan. 9, 2004

Related U.S. Application Data
(63) Continuation of application No. 10/028,627, filed on Dec. 20, 2001.

(51) Int. Cl. B01D 29/11

(52) U.S. Cl. 210/497.01

(57) ABSTRACT

A filter element and method has at least two fluid barriers disposed in the filter media, which do not extend the length of the filter. The barriers direct the fluid to be filtered through a path in the filter element, and the fluid makes at least two passes in the media.

### BACKGROUND

This invention relates to the filtration of fluids including mixtures of more than one fluid and fluids with solids.

Filters and methods of filtration are widely utilized in a number of commercial and industrial applications and also in laboratory, clinical and residential settings. Such filters and methods may be used to both purify fluids (e.g., liquids and gases) and to extract compounds (e.g., fluids and solids) contained in the fluids.

There are instances when fluids need treatment to remove more than one impurity, such as removal of particles and another contaminating fluid, necessitating the use of multiple filter media. In some cases there are confined areas for filter placement.

A filter that provides adequate purification in a relatively small space is desired. In other cases a filter that provides multiple passes through one or more filter media is sought.

The present invention addresses these and other filtration issues through a unique design and method as described herein.

### SUMMARY OF THE INVENTION

In general, the invention features a filter with at least two layers of filter media surrounding a permeable core separated by a barrier disposed in the media, which barrier has a permeable area towards one end of the barrier or does not extend the entire length of the filter element. The filter has a top end cap covering and extending over the top end of the permeable core and a bottom end cap extending over and in fluid communication with the bottom end of the core. The filter element of the present invention can have more than one barrier disposed inside the filter element. In one embodiment, a layer of filter media surrounds the core. Different media may be used in the filter element as desired to remove impurities. Primarily, the media are either pleated filter media or non-pleated filter media. The filter media may be selected to separate the undesirable impurities from the fluid, whether they are particles or other fluids. The pleated media can include cellulose, polypropylene, polyethylene, polyester, fiberglass, cloth, paper, nylon, orlon, teflon or combinations thereof. The non-pleated media can be a granular media, spunbonded media or solid media. The media can be surrounded by a rigid support such as a mesh. In the case of granular media, a tightly woven mesh may be used to confine the granules. A solid media may also be used.

A layer of filter media surrounds the permeable core. The permeable core may be a solid sleeve with perforations to allow fluid flow into the center of the core. The perforations may be arranged throughout the length of the core or aggregated towards one end of the permeable core. Also, the permeable core can be made of a non-perforated material through which fluid may pass. A first barrier surrounds the filter media layer around the core, and in some embodiments the sleeve extends from either the top or the bottom end cap but does not extend the entire length of the filter element. There is a gap between the terminal portion of the sleeve and one of the end caps. Preferably, the sleeve is secured to the end cap from which it extends to stabilize the sleeve within the filter media. In the simplest design, another layer of media surrounds the barrier. The fluid flows into the filter element and must flow through the gap around the barrier and through the filter media into the permeable core.

In other embodiments, multiple barriers may be used to create fluid flow through the filter such that the sleeves extend alternatively from the bottom end cap and the top end cap but do not extend throughout the length of the filter element, creating a path of travel for fluid flow generally from the top to the bottom of the filter before the fluid passes through the permeable core.

The top end caps and bottom end caps can be used to retain the filter media and permeable core by affixing the end of the permeable core to the top end cap and the bottom end cap and similarly affixing the sleeves.. In one embodiment the sleeves are solid, extending the entire length of the filter element, and are affixed at both ends to the top end caps and the bottom end caps. The top to bottom fluid flow path is created by having a fluid permeable area at one end of each barrier in alternating fashion from the top end cap to the bottom end cap. The permeable portion of the sleeve may be perforations or a fluid permeable material.

This invention also includes a method of filtering a fluid. The fluid to be filtered is placed under pressure and confined under pressure during the filtering process. The fluid flows through a layer of filter media and is allowed to pass through a permeable portion at the end of a barrier. The fluid then flows in a path containing filter media between two barriers and is allowed to pass through a permeable portion at the end of the second barrier through the path containing the filter media. The filter media is then collected at an outlet after it has flowed through the permeable portion of the second barrier. This method may be augmented by flowing the fluid in paths containing filter media between additional barriers, each barrier having a permeable portion at one end through which the filter fluid can pass.

### DETAILED DESCRIPTION OF THE DRAWINGS

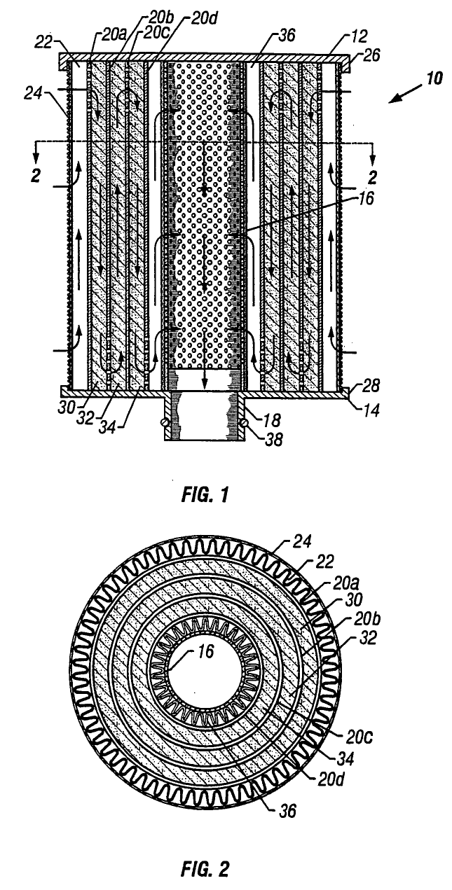

FIG. 1 is a drawing of a longitudinal section of the filter showing the flow pattern.

FIG. 2 is a cross-section of the filter through 2-2 of FIG. 1.

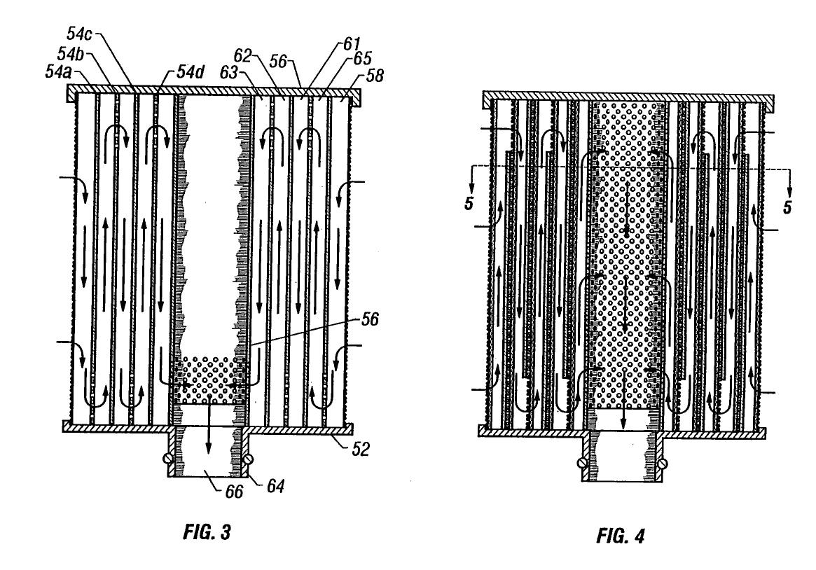

FIG. 3 is a schematic of an alternative embodiment of the filter in a longitudinal section.

FIG. 4 is an alternative embodiment in a longitudinal section.

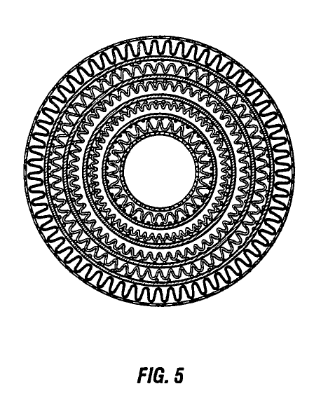

FIG. 5 is a cross-section through 5-5 of FIG. 4.

### DETAILED DESCRIPTION OF THE INVENTION

FIG. 1 is a longitudinal section through a filter of the present invention that illustrates the invention. The filter is shown as a cylindrical body, but can be any shape that accommodates the structure and method described herein.

The filter 10 has a top end cap 12 and bottom end cap 14 with the permeable core 16 extending there through with end cap having a neck 18 in fluid communication with the permeable core 16. The top end cap 12 and bottom end cap 14 are made of materials that are impermeable to the fluids that are filtered. The permeable core 16 has perforations for fluid flow as shown in FIG. 1 or is made of a fluid permeable material. The top end cap 12 covers the upper end of core 16 and prevents fluid from flowing out of the top end of the filter in the embodiment shown in FIG. 1. In some cases, the top end cap 12 is affixed to the upper end of the core 16. The lower end of the core 16 is in communication with a circular opening of bottom end cap 14 which extends into neck 18 of the bottom end cap 14. In some embodiments, the bottom edge of core 16 is affixed to the inside of the end cap 14.

Extending from the top end cap 12 and bottom end cap 14 is at least one sleeve, spaced from the core 16, which acts as a barrier to fluid. In one embodiment, the sleeve is a solid barrier but has a permeable portion toward one end of the sleeve. As shown in FIG. 1, there can be multiple sleeves 20a, 20b, 20c and 20d which extend from the inside of the top end cap 12 to the bottom end cap 14. Each sleeve is spaced from each other with filter media disposed in between each sleeve. Sleeve 20d, which is closest to the core 16, is spaced from the core. Each of the sleeves has a fluid permeable portion, which in FIG. 1 is illustrated as perforations in the sleeve. The fluid permeable portion can be a material that permits fluid flow instead of perforations.

Filter media is disposed in the spaces created by the sleeves. Any type of filter media can be used, including pleated media, spun media, granular media, solid media and other media known to those skilled in the art.

In FIG. 1 the pleated type media is shown as the layer on the outside of the filter at numeral 22. The pleated media can include cellulose, polypropylenes, polyethylene, polyester, fiberglass, cloth, paper, nylon, orlon, teflon and combinations thereof. This outer pleated sleeve layer 22 is surrounded by a polymer mesh layer 24 which serves to hold the pleated media layer 22. The outer pleated media layer and the outer polymer mesh 24 extend the entire length of the filter from top end cap 12 to bottom end cap 14. In FIG. 1 each end cap has a lip which extends over the edge of the outer pleated layer and outer polymer mesh at the top edge and bottom edge shown at 26 and 28, respectively. The lips secure the outer filter media layer of the filter. In FIG. 1 the lips of end caps confine the polymer mesh layer 24.

FIG. 1 illustrates the use of more than one filter media in the invention. Between sleeves 20a, 20b, 20c and 20d the layers of granular media such as carbon are disposed referenced at numerals 30, 32 and 34. The granular media generally fills the space defined by the sleeves from the top and bottom end caps. FIG. 1 shows a combination of pleated media and granular media. However, the same type of media can be used in the spaces defined by the sleeves. Also, more than two types of filter media can be used depending on the fluid and impurities to be removed from the fluid.

As shown in FIG. 1, the filter media layer next to and surrounding the permeable core is an inner pleated layer of media 36. FIG. 1 illustrates the use of several layers of media and different types of media creating flow through the filter from top to bottom, thereby increasing the travel and filtering of the fluid. The sleeves 20a, 20b, 20c and 20d have fluid permeable portions, illustrated as perforations in one end of the sleeve, that alternate on each sleeve from the top and the bottom of the filter. The fluid enters the filter through the outer filter media layer. Generally, the fluid is under pressure so that it flows through to the core. As shown by the arrows, the fluid flows through the perforations in sleeve 20a toward the top of the filter and into the granular media layer 30 disposed in the space between sleeves 20a and 20b. The fluid then can pass through the perforations in sleeve 20b, which are toward the bottom of the filter, so that the fluid travels substantially the length of the filter. In a similar manner, the fluid then travels most of the length of the filter in the granular media disposed between sleeves 20b and 20c, and the filtered fluid passes through the openings in the sleeve 20c toward the top of the filter. The fluid then makes another pass through most of the length of the filter through granular media layer 34 between sleeves 20c and 20d, passing through the perforations in sleeve 20d into the inner pleated layer 36, which surrounds core 16 and allows fluid flow into the center of the core. In FIG. 1 the core is shown as perforated, but other structures or materials that allow fluid flow into the center of the filter can be used.

The fluid flows through the center of the core 16 and out neck 18 of the bottom end cap, which is in fluid communication with the core. The filtered fluid is then transported to a receptacle or intake for filtered fluid. In FIG. 1 neck 18 is shown with O-ring 38 for seating in an intake pipe or line.

Although FIG. 1 shows multiple filter layers, there can be as few as two layers separated by a barrier with a fluid permeable portion at one end of the barrier. FIG. 1 illustrates the use of two types of filter media such that the fluid can be filtered for particles by the pleated media and impurities by the granular media.

FIG. 2 is a cross-section of the filter of FIG. 1 at line 2-2 showing the layers of media and other filter components. Starting from the outside is polymer mesh layer 24 that surrounds the pleated media 22. Then sleeves 20a, 20b, 20c and 20d alternate with granular media layers 30, 32 and 34 in between the sleeves. The inner pleated layer 36 surrounds core 16.

The flow pattern in FIG. 1 is for an outside-in flow pattern so the filtered fluid flows to the inner core member 16. However, the same configuration can be used for inside-out flow where the fluid enters the core, travels substantially the length of the filter layers separated by the barrier sleeves and exits through the outside layer of filter media. Typically, the filter will reside in a housing that collects the filtered fluid and exits through an outflow line that communicates with neck 18, which assembly is well known to those skilled in the art and not shown here. However, the filter can be used in any application where a filter is needed. The filter of the present invention is particularly suited for applications where high purity is a factor since the fluid passes through a volume of media or in a confined area since the filter can be compact yet provide thorough filtering.

The invention also includes the method of filtering a fluid. The fluid for filtering is selected and placed under pressure and flowed through a layer of filter media along a length of a first barrier. At one end of the barrier the fluid passes through a permeable portion. After the fluid passes through the permeable portion, it flows through a path of media on the other side of the barrier. The fluid then flows through filter media between the first barrier and a second barrier and then through a permeable portion of the second barrier in a length which is in the opposite direction to the travel on the first barrier. The second barrier has a permeable portion of an end opposite to the permeable portion of the first barrier. Multiple barriers may be used with permeable portions at alternating ends.

The method is illustrated in all of the figures. Using FIGS. 1 and 2 as illustrations, the pressurized fluid enters the filter and flows through the pleated media 22 and passes through the permeable portion at the end of first barrier 20a. The fluid then flows in a path or channel containing filter media 30 between first barrier 20a and second barrier 20b. The fluid is then allowed to pass through a permeable portion at the end of second barrier 20b. The permeable portion of barrier 20b is spaced from the permeable portion at the end of barrier 20a allowing a length of travel in the filter media in a channel between the two barriers. At this point the filtered liquid passing through the permeable portion of second barrier can be collected if sufficient impurity removal has been accomplished.

FIGS. 1 and 2 also show an alternative embodiment of the method of this invention wherein additional purification of the fluid may be obtained. After the fluid passes through the permeable portion of barrier 20b, the fluid travels in a path between barrier 20b and barrier 20c containing another layer of filter media 32. In FIGS. 1 and 2 filter media layer 22 is shown as pleated media and filter media 30 and 32 are shown as granular media. Any type of filter media may be used to practice the invention depending on the type of fluid to be filtered and the contaminants to be removed.

In FIGS. 1 and 2 additional filter media layers 34 and 36 are shown through which the filtered fluid would pass. Additional barrier 20d is also shown that creates the path with barrier 20c for fluid flow. The permeable portion of barrier 20d is spaced from the permeable portion on 20c and between each of the barriers is the filter media 34. The fluid is collected after the filtration process.

FIG. 3 is an alternative embodiment similar to FIGS. 1 and 2 shown in schematic form. The sleeves are placed so that the fluid permeable ends which are perforated are alternately placed from the top and bottom of the filter element with filter media layers in between. Top end cap 50 and bottom end cap confine sleeves 54a, 54b, 54c and 54d. Filter media layers (not shown) surround sleeves 54a and in between sleeves 54b, 54c, 54d and the partially permeable core 56. The filter media layers are disposed at 58, 60, 61, 62 and 63, respectively. Core has perforations at one end. As shown in FIG. 3, the perforations are toward the neck 64 of end cap 52, which neck is in fluid communication with the permeable core and provides outlet 66 for the filtered fluids. The arrows indicate the preferred fluid flow through the filter for outside/in filtering process. By reducing the perforations in the core towards the end cap an additional travel path for the fluid is provided between the sold portion of core and sleeve 54d. Also, in the event two fluids with different specific gravities were being separated, the lighter fluid would remain at the top of the filter allowing the denser fluid to separate and flow through the perforations on the core. In the case where the heavier fluid is undesirable, the core can be solid toward the end cap and the perforations can be disposed at the core towards the top end cap 50.

FIG. 4 is an alternative embodiment where the sleeves do not extend the entire length of the filter. There are gaps between the terminal end of the sleeves such that the sleeves extend alternatively from the top end cap and the bottom end cap but do not extend throughout the length of the filter element. The gap between the terminal end of the sleeve and the end caps provides a fluid flow path around the end of the sleeve rather than having a sleeve that extends throughout the length of the filter and has a permeable portion at one end. As shown in FIG. 4, the sleeves extend alternatively from the bottom end cap and the top end cap providing a fluid path through the filter element such that the fluid must travel through a significant longitudinal part of the filter media. FIG. 4 is shown with five layers of pleated filter media which is separated by four sleeves. The pleated filter media layers are surrounded by polymer mesh. A permeable core extends throughout the length of the filter element and is in fluid communication with a neck formed in the central portion of the bottom end cap. The arrows show the fluid flow through the filter element that creates the longitudinal paths for passage of the fluid. This arrangement and the other embodiments allow for filtration with multiple passes through fluid media which can be achieved in a confined space.

Other embodiments of this invention are apparent to those skilled in the art.

What is claimed is:

1. A filter comprising:
a permeable core;
a layer of filter media surrounding the core;
a top end cap covering and extending over the top end of the core;
a bottom end cap extending over and in fluid communication with the bottom end of the core providing a fluid outlet from the filter;
a first barrier that is a sleeve surrounding the filter media layer around the core, which sleeve extends from one of the top end cap and the bottom end cap and does not extend the entire length between the top end cap and bottom end caps;
a second barrier that is a sleeve spaced from the first barrier having a second layer of filter media disposed between the first barrier and the second barrier, said second barrier not extending the length of the filter from the top end cap to the bottom end cap with the gap on the opposite end of the filter from the gap created by the first barrier; and
a third layer of filter media surrounding the outside of the second barrier.

2. A filter of claim 1 further comprising a top end cap and a bottom end cap retaining the filter media and the permeable core.

3. A filter of claim 1 further comprising a retaining material surrounding the filter media surrounding the outside of the second barrier.

4. A filter of claim 1 wherein the filter media is a combination of pleated filter media surrounding the outside of the second barrier, granular media disposed between the first barrier and second barrier, and pleated media surrounding the central core.

5. A filter of claim 4 wherein a polymer mesh surrounds the pleated filter media layer and extends substantially the length from the top end cap and the bottom end cap.

6. A filter of claim 1 wherein the permeable core is permeable toward one end of the filter.

7. A filter comprising:
a permeable core;
a layer of filter media surrounding the core;
a top end cap covering and extending over the top end of the core;
a bottom end cap extending over and in fluid communication with the bottom end of the core providing a fluid inlet from the filter;
a first barrier that is a sleeve surrounding the filter media layer around the core, which extends from the top end cap and the bottom end cap and through a fluid permeable area of the sleeve toward one end of the filter;
a second barrier that is a sleeve spaced from the first barrier having a second layer of filter media disposed between the first barrier and the second barrier, said second barrier having a fluid permeable area of the sleeve on the end of the second barrier on the end of the filter opposite to the permeable part of the first barrier; and
a third layer of filter media surrounding the outside of the second barrier.

8. A filter of claim 7 further comprising a top end cap and a bottom end cap retaining a filter media and the permeable core.

9. A filter of claim 7 comprising a retaining material surrounding the filter media surrounding the outside of the second barrier.

10. A filter of claim 7 wherein the filter media is a combination of pleated filter media surrounding the outside of the second barrier, granular media disposed between the first barrier and second barrier, and plated media surrounding the central core.

11. A filter comprising:
a filter media for filtering fluid;
a permeable core in the filter media, said filter media surrounding the core;
a top end cap covering the filter media and affixed to the top end of the core;
a bottom end cap covering the filter media and in fluid communication with the bottom end of the core; and
a first barrier and second barrier that are sleeves disposed in the filter media and spaced from each other that extend from the top end cap to the bottom end cap that have a fluid permeable portion towards opposite ends relative to the top end cap and the bottom end cap creating a flow path through the media from one end to the other.

12. A filter of claim 11 further comprising:
at least one additional barrier that is a sleeve disposed in the filter media spaced from the first and second barrier that has a fluid permeable portion towards one end of the sleeve.

13. A filter of claim 12 wherein the permeable core is permeable toward one end of the filter.

14. A method of filtering a fluid comprising the steps of:
placing a selected fluid under pressure;
confining the fluid under pressure in the filter during the filtering process;
flowing the fluid through a layer of filter media;
allowing the fluid to pass through a permeable portion at the end of the first barrier;
flowing the fluid in a path containing filter media between a first and second barrier;
allowing the fluid to pass through a permeable portion of the end of the second barrier at the end of the path containing filter media; and
collecting the filtered fluid in an outlet of the filter after the fluid has flowed through the permeable portion of the second barrier.

15. A method of filtering a fluid of claim 14 further comprising adding the steps of:
flowing the fluid in a path containing filter media between the second barrier and at least a third barrier wherein the third barrier has a permeable portion at one end through which the filtered fluid can pass; and
collecting the filtered fluid after the fluid has flowed through the permeable portion of the third barrier.
